(19) United States
(12) Patent Application Publication
(10) Pub. No.: US 2025/0391050 A1
(43) Pub. Date: Dec. 25, 2025

(54) STANDARD JIG, APPARATUS, AND METHOD FOR MEASURING CLEARANCE

(71) Applicant: SAMSUNG SDI CO., LTD., Yongin-si (KR)

(72) Inventors: Inyong Jung, Yongin-si (KR); YONGSEUNG SHIN, Yongin-si (KR); HEE TAEK LIM, Yongin-si (KR)

(21) Appl. No.: 19/176,723

(22) Filed: Apr. 11, 2025

(30) Foreign Application Priority Data
Jun. 24, 2024 (KR) 10-2024-0082215

(51) Int. Cl. G06T 7/73; G01B 11/14

(52) U.S. Cl. CPC G06T 7/74; G01B 11/14; G06T 2207/30108

(57) ABSTRACT

A standard jig for measuring clearance includes a first block having a stepped portion including a plurality of steps, each having a different clearance width, and a second block coupled to the first block such that the second block partially overlaps the stepped portion of the first block.

### CROSS-REFERENCE TO RELATED APPLICATION

The present application claims priority to and the benefit of Korean Patent Application No. 10-2024-0082215, filed on Jun. 24, 2024, in the Korean Intellectual Property Office, the entire disclosure of which is incorporated herein by reference.

### BACKGROUND

### 1. Field

Aspects of embodiments of the present disclosure relate to a standard jig, apparatus, and method for measuring clearance.

### 2. Description of the Related Art

Different from primary batteries that are not designed to be charged, secondary batteries are designed to be discharged and recharged. Low-capacity secondary batteries are used in small, portable electronic devices, such as smart phones, feature phones, notebook computers, digital cameras, and camcorders, while large-capacity secondary batteries are widely used as power sources for driving motors, such as of hybrid vehicles or electric vehicles, and for power storage.

A secondary battery generally includes an electrode plate. Generally, the electrode plate is manufactured by processing the electrode plate by a shearing mold. A mold for the electrode plate includes a punch and a die. An interval (or space) between the punch and the die is called clearance.

If the clearance is not appropriate, overall quality of a product is degraded and the lifespan of the mold is reduced because a shear cross section is irregular and the occurrence of an contamination substance, such as a burr, becomes severe.

The thinnest part from among parts in which shearing occurs in the electrode is a metal base material. The thickness of the metal base material is very small, for 1 example, about 10 μm. Accordingly, to shear the electrode without generating a burr, which may occur in the shearing surface of the electrode, the metal base material is processed to have a numerical value of very small clearance. However, the clearance of a shearing mold that is precisely processed and used to manufacture the electrode of a secondary battery cannot be measured by conventional measurement equipment and, thus, depends on a degree of precision of a processing machine that processes the mold.

Furthermore, a defective product occurring as a result of a slight change in the clearance between the punch and the die cannot be detected although the slight change occurs in a repeated shearing process after the clearance is set at the beginning of an operation.

Furthermore, conventional clearance measurement equipment can relatively analyze fine clearance between the punch and the die but has difficulty quantitatively evaluating the size of the clearance due to the absence of a measurement criterion.

The above information disclosed in this Background section is for enhancement of understanding of the background of the present disclosure, and therefore, it may contain information that does not constitute prior art.

### SUMMARY

Embodiments of the present disclosure provide a standard jig, apparatus, and method for measuring clearance which allow for a clearance measurement criterion and a clearance evaluation process to be prepared.

However, the aspects and features of the present disclosure are not limited to the above-listed aspects and features, and other aspects and features not mentioned herein will be clearly understood by those skilled in the art from the detailed description below.

A standard jig for measuring clearance, according to embodiments of the present disclosure, includes a first block having a stepped portion including a plurality of steps, each having a different clearance width; and a second block coupled to the first block such that the second block partially overlaps the stepped portion of the first block.

The standard jig may further include a linear block supported by a bottom of the second block to adjust a degree that the second block overlaps the stepped portion of the first block.

The first block may have first bolt holes, the second block may have second bolt holes, and a bolt may be inserted into the first bolt hole and the second bolt hole to couple the first block and the second block.

The second bolt holes may have a vertically extending slot shape to allow for adjusting a degree that the second block overlaps the stepped portion of the first block.

An apparatus for measuring clearance, according to another embodiment of the present disclosure, includes: a light source configured to radiate light toward a bottom of a standard jig for measuring clearance, the standard jig including a first block having a stepped portion including a plurality of steps, each having a different clearance width and a second block coupled to the first block such that the second block partially overlaps the stepped portion of the first block; a camera configured to photograph the stepped portion of the first block in a state in which the light is radiated by the light source; and a controller configured to analyze light that passes through each of the steps of the stepped portion, for each step, based on an image of the stepped portion obtained by the camera.

The apparatus may further include a database configured to store results of the analysis of the light for each step.

The controller may be configured to analyze the light that passes through each of the steps of the stepped portion in a pixel unit.

The light source may be configured to radiate light under a mold unit including a die and a punch that vertically moves through the die, and the camera may be configured to photograph a space between the die and the punch in the state in which the light is radiated by the light source.

The controller may be configured to analyze light that is measured after passing between the die and the punch based on an image of the space between the die and the punch obtained by the camera, the controller may be configured to compare results of the analysis of the measured light and results of the analysis of the light for each step, and the controller may be configured to derive a clearance between the die and the punch based on results of the comparison.

The controller may be configured to analyze the light that passes through each of the steps of the stepped portion for each degree that the second block overlaps the stepped portion of the first block.

The apparatus may further include a database configured to store results of the analysis of the light for each step and results of the analysis for each degree that the second block overlaps the stepped portion of the first block.

The light source may be configured to radiate the light toward the bottom of the standard jig for measuring clearance in a state in which a linear

block configured to adjust the degree that the second block overlaps the stepped portion of the first block is supported by a bottom of the second block.

A method of measuring a clearance, according to another embodiment of the present disclosure, includes: radiating light from a light source toward a bottom of a standard jig for measuring clearance, the standard jig including a first block having a stepped portion including a plurality of steps, each having a different clearance width, and a second block coupled to the first block such that the second block partially overlaps the stepped portion of the first block; photographing, by a camera, the stepped portion in a state in which the light is radiated by the light source; and analyzing light that passes through each of the steps of the stepped portion for each step, through a controller, based on an image of the stepped portion obtained by the camera.

The method may further include storing results of the analysis of the light for each step through a database.

The analyzing of the light may include analyzing the light that passes through each of the steps of the stepped portion in a pixel unit.

The method may further include: radiating the light from the light source under a mold unit including a die and a punch that vertically moves through the die; and photographing, by the camera, a space between the die and the punch in a state in which the light is radiated by the light source.

The method may further include: analyzing light that is measured after passing between the die and the punch, through the controller, based on an image of the space between the die and the punch obtained by the camera; and comparing results of the analysis of the measured light and results of the analysis of the light for each step and deriving a clearance between the die and the punch based on results of the comparison.

The analyzing of the light may include analyzing the light that passes through each of the steps of the stepped portion for each degree that the second block overlaps the stepped portion of the first block.

The method may further include storing results of the analysis of the light for each step and results of the analysis for each degree that the second block overlaps the stepped portion of the first block through a database.

The radiating of the light may include radiating the light toward a bottom of the standard jig for measuring clearance by the light source in a state in which a linear block configured to adjust the degree that the second block overlaps the stepped portion of the first block is supported by a bottom of the second block.

The standard jig for measuring clearance, according to embodiments of the present disclosure, allows for a clearance measurement criterion and a clearance evaluation process to be prepared by including the stepped portion including a plurality of steps, each having a different clearance width.

In the apparatus and method for measuring clearance, according to embodiments of the present disclosure, light is radiated toward the bottom of the standard jig for measuring clearance. An image of the stepped portion of the standard jig for measuring clearance is photographed and analyzed. The results of the analysis are databased (e.g., stored) according to various types of clearance and by various amounts of insertion. Accordingly, clearance can be quantitatively evaluated by establishing a clearance measurement criterion, and proper clearance can be checked through a comparison with the quality of an electrode.

Furthermore, the apparatus and method for measuring clearance, according to embodiments of the present disclosure, can accurately measure clearance between the punch and the die by comparing results that have been analyzed by various types of clearance and by various amounts of insertion by using the standard jig for measuring clearance with actually measured results and can improve a notching process by checking the punch and the die.

However, aspects and features of the present disclosure which may be obtained by the present disclosure are not limited to the aforementioned aspects and features, and other aspects and features not described above may be evidently understood by those skilled in the art from the following description.

### BRIEF DESCRIPTION OF THE DRAWINGS

The following drawings attached to this specification illustrate embodiments of the present disclosure and further describe aspects and features of the present disclosure along with the aforementioned contents of the disclosure. Accordingly, the present disclosure should not be construed as being limited to the content described in the drawings, in which:

FIG. 1 is an exploded view of a standard jig for measuring clearance according to embodiments of the present disclosure.

FIG. 2 is a coupled view of the standard jig for measuring clearance shown in FIG. 1.

FIG. 3 is a perspective view of a die and a punch according to embodiments.

FIG. 4 is a cross-sectional view of the die and the punch according to embodiments.

FIG. 5 is a diagram illustrating an apparatus for measuring clearance according to embodiments of the present disclosure.

FIG. 6 is a plan view of a standard jig for measuring clearance according to embodiments of the present disclosure.

FIG. 7 is a diagram illustrating an image of a standard jig for measuring clearance according to embodiments of the present disclosure and results of the analysis of the image.

FIG. 8 is a side cross-sectional view of a standard jig for measuring clearance according to embodiments of the present disclosure.

FIGS. 9 to 12 are diagrams illustrating differences according to an overlap degree of the standard jig for measuring clearance according to embodiments of the present disclosure.

FIG. 13 is a graph illustrating results in which an image of a standard jig for measuring clearance according to embodiments of the present disclosure was analyzed by types of clearance and by amounts of insertion.

FIG. 14 is a diagram illustrating an apparatus for measuring clearance according to embodiments of the present disclosure.

FIG. 15 is a flowchart describing steps of a method of measuring clearance according to embodiments of the present disclosure.

### DETAILED DESCRIPTION

Embodiments of the present disclosure will be described below, in detail, with reference to the accompanying drawings. Prior to the description, it is noted that the terms or words used in this specification and claims should not be construed as being limited to their common or dictionary meanings but instead should be understood to have meanings and concepts consistent with the spirit of the present disclosure based on the principle that an inventor can define the concept of each term suitably in order to describe his/her own invention in the best way possible. Because embodiments described in this specification and the configurations illustrated in the drawings are merely examples of the present disclosure and do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof but do not preclude the presence or addition of one or more other features, integers, steps, operations, elements, components, and/or groups thereof.

To facilitate understanding of the present disclosure, the accompanying drawings may not be drawn to scale and the dimensions of some components may be exaggerated. It should be noted that the same reference numerals are designated to the same components in different embodiments.

Reference to two compared elements, features, etc. as being “the same” means that they are “substantially the same”. Therefore, the phrase “substantially the same” may include a deviation that is considered low in the art, for example, a deviation of about 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions, such as “at least one” and “one or more,” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed below may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions.

The controller, database, and/or any other relevant devices or components according to embodiments of the present disclosure described herein may be implemented utilizing any suitable hardware, firmware (e.g., an application-specific integrated circuit), software, and/or a suitable combination of software, firmware, and hardware. For example, the various components of the controller and/or database may be formed on one integrated circuit (IC) chip or on separate IC chips. Further, the various components of the controller and/or database may be implemented on a flexible printed circuit film, a tape carrier package (TCP), a printed circuit board (PCB), or formed on a same substrate as the controller and/or database. Further, the various components of the controller and/or database may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device or the functionality of a particular computing device may be distributed across one or more other computing devices without departing from the scope of the exemplary embodiments of the present disclosure.

The terminology used herein is for the purpose of describing embodiments of the present disclosure and is not intended to limit the present disclosure.

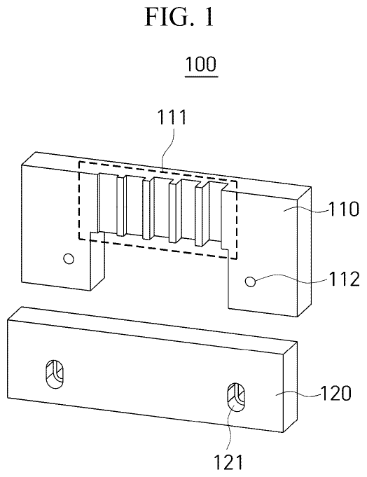

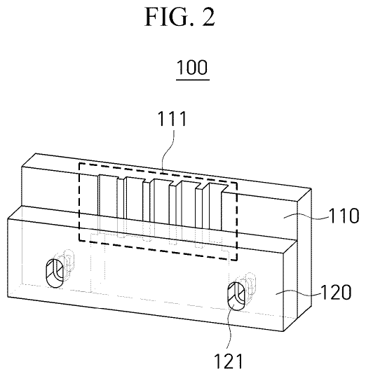

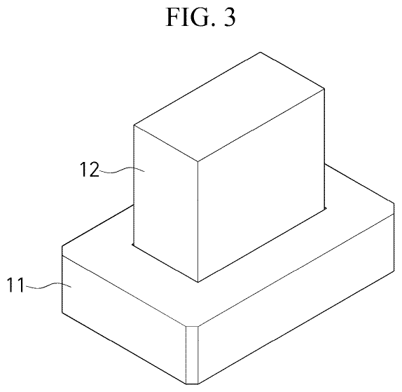

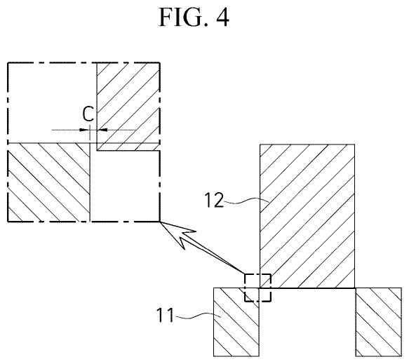

FIG. 1 is an exploded view of a standard jig for measuring clearance according to embodiments of the present disclosure. FIG. 2 is a coupled view of the standard jig for measuring clearance shown in FIG. 1. FIG. 3 is a perspective view of a die and a punch according to embodiments. FIG. 4 is a cross-sectional view of the die and the punch according to embodiments.

Referring to FIGS. 1 and 2, a standard jig 100 for measuring clearance according to embodiments of the present disclosure may include a first block part (e.g., a first block) 110 and a second block part (e.g., a second block) 120.

The first block part 110 may have a stepped part (e.g., a stepped portion) 111 in which a plurality of steps, each having clearance of a different width, has been formed. In various embodiments, in the stepped part 111 of the first block part 110, the steps may be formed to have clearance in a range of about 1 μm to about 5 μm through precision processing. A step is obtained by imitating clearance C between a die 11 and a punch 12 as illustrated in, for example, FIGS. 3 and 4. In various embodiments, the first block part 110 may have first bolt holes 112.

The second block part 120 is combined with (e.g., is coupled to) the first block part 110 so that the second block part 120 partially overlaps the stepped part 111. In various embodiments, the second block part 120 may have second bolt holes 121.

In the standard jig 100 for measuring clearance according to embodiments of the present disclosure, a bolt may be inserted into the first bolt hole 112 and the second bolt hole 121 so that the first block part 110 and the second block part 120 are combined. In this case, to adjust a degree that the stepped part 111 and the second block part 120 overlap, the second bolt hole 121 may be elongated in an up and down direction (e.g., the second bolt hole 121 may be a slot). The standard jig 100 for measuring clearance according to embodiments of the present disclosure may imitate a situation in which the punch 12 is inserted into the die 11, that is, the amount of insertion, by adjusting the degree that the stepped part 111 and the second block part 120 overlap each other.

An apparatus for measuring clearance according to embodiments of the present disclosure can establish a clearance measurement criterion and accurately measure the clearance by using the standard jig 100 for measuring clearance having such a structure.

Hereinafter, a process of the apparatus for measuring clearance according to embodiments of the present disclosure measuring the clearance by using the standard jig 100 for measuring clearance is described with reference to drawings.

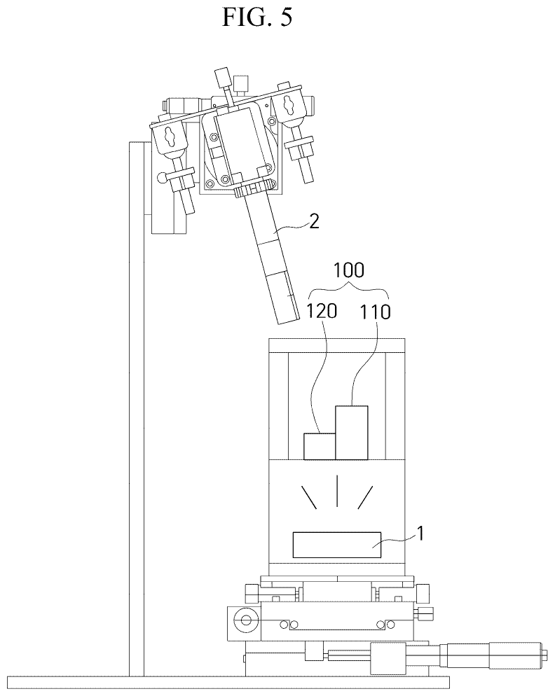

FIG. 5 is a diagram illustrating an apparatus for measuring clearance according to embodiments of the present disclosure that photograph the standard jig for measuring clearance.

Referring to FIG. 5, the apparatus for measuring clearance according to embodiments of the present disclosure may include an illumination part (e.g., a light source) 1, a photographing part (e.g., a camera) 2, a controller, and a database part (e.g., a database or memory). In various embodiments, the apparatus for measuring clearance may further include a support part (e.g., a support) that supports the illumination part 1 and the photographing part 2, a driving part (e.g., a driver) that drives the illumination part 1 and the photographing part 2 to their locations, and a frame in which the standard jig 100 for measuring clearance or the die 11 and the punch 12 are installed, in addition to the above components. However, the components for the support and driving as described above may have various structures, and detailed descriptions thereof are omitted.

The illumination part 1 may radiate light to (or toward) the bottom of the standard jig 100 for measuring clearance. When the photographing part 2 photographs the stepped part 111, it may be difficult to identify the steps of the standard jig 100 or a space between the die and the punch because the steps or the space appears dark in the image. The illumination part 1 may radiate light between the steps of the standard jig 100 or the space between the die 11 and the punch 12 so that a boundary between the steps of the standard jig 100 or a boundary between the die 11 and the punch 12 can be clearly identified in the image. As described above, when the standard jig 100 for measuring clearance is placed in the apparatus for measuring clearance according to embodiments of the present disclosure and light is illuminated from the illumination part 1 under the standard jig 100 between the steps, the light passes through the space between the die 11 and the punch 12 such that the clearance C can be imitated.

The photographing part 2 photographs the stepped part 111 in the state in which the light has been radiated by the illumination part 1. The photographing part 2 may be a camera that photographs a subject, for example. The photographing part 2 may be an ultra-high definition (8K) camera from among various cameras, but the present disclosure is not limited thereto.

The controller may analyze the light that passes through each of the steps of the stepped part 111, for each step, based on the image of the stepped part 111 that is obtained by the photographing part 2. The database part stores the results of the analysis of the light for each step.

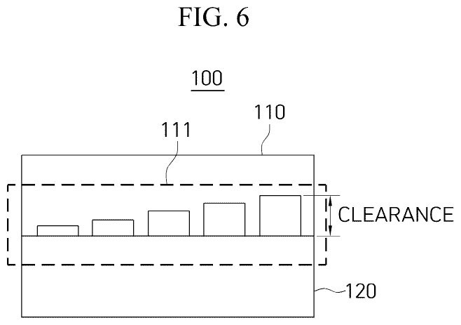

Hereinafter, an example in which the apparatus for measuring clearance according to embodiments of the present disclosure photographs and analyzes the standard jig 100 for measuring clearance is described with reference to FIGS. 6 to 13. FIG. 6 is a plan view of the standard jig for measuring clearance according to embodiments of the present disclosure.

Referring to FIG. 6, the first block part 110 of the standard jig 100 for measuring clearance according to embodiments of the present disclosure may include the stepped part 111 in which a plurality of steps each having a different clearance width has been formed. For example, steps respectively having a clearance of 1 μm to 5 μm may be formed in the stepped part 111. The step of the stepped part 111 is obtained by imitating the clearance C between the die 11 and the punch 12.

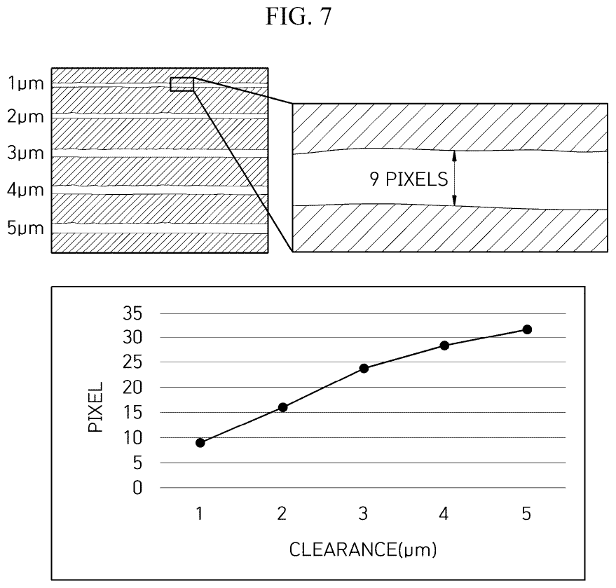

FIG. 7 is a diagram illustrating an image of the standard jig for measuring clearance according to embodiments of the present disclosure and the results of the analysis of the image.

Referring to FIG. 7, the illumination part 1 may radiate light to the stepped part 111 having a plurality of steps, each having clearance of a different width. The controller may analyze light that passes through each of the steps of the stepped part 111, for each step, based on an image of the stepped part 111, which has been photographed by the photographing part 2. In various embodiments, the controller may analyze the light that passes through each of the steps of the stepped part 111 in a pixel unit. Furthermore, in various embodiments, the controller may collect (e.g., may analyze) only pixels in each of which a gray value having a numerical value range of 0 to 255 is 80% or more on the basis of 255, that is, a maximum value, as a criterion for evaluating a degree of light intensity with respect to the image and may use the pixels to analyze the light.

As illustrated in FIG. 7, the number of pixels of the image of the stepped part 111 may increase as the width of the step increases. However, the number of pixels does not increase uniformly as the width of the step increases. Accordingly, the apparatus for measuring clearance according to embodiments of the present disclosure uses the database to analyze the results of light by re-measuring and analyzing the light multiple times through the standard jig for measuring clearance. The results of the analysis of the light that have been databased as described above may be compared and used when the clearance C between the die 11 and the punch 12 is actually measured.

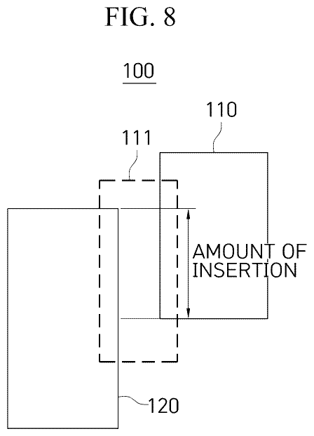

FIG. 8 is a side cross-sectional view of the standard jig for measuring clearance according to embodiments of the present disclosure.

Referring to FIG. 8, the standard jig 100 for measuring clearance according to embodiments of the present disclosure may adjust the degree that the stepped part 111 and the second block part 120 overlap each other. As described above, the standard jig 100 for measuring clearance according to embodiments of the present disclosure may imitate a situation in which the punch 12 is inserted into the die 11, that is, the amount of insertion, by adjusting the degree that the stepped part 111 and the second block part 120 overlap each other.

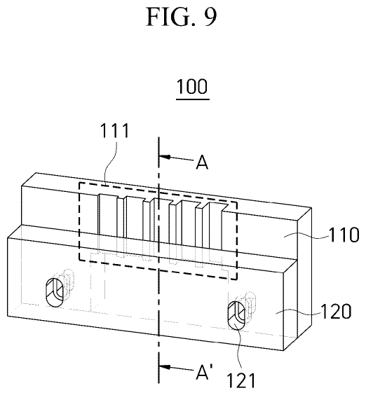

FIGS. 9 to 12 are diagrams illustrating differences according to an overlap degree of the standard jig for measuring clearance according to embodiments of the present disclosure.

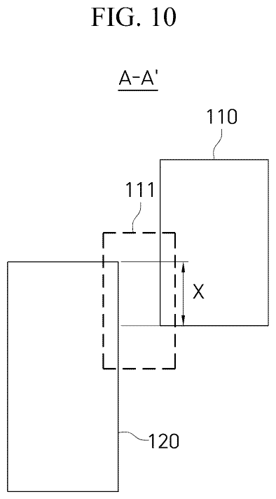

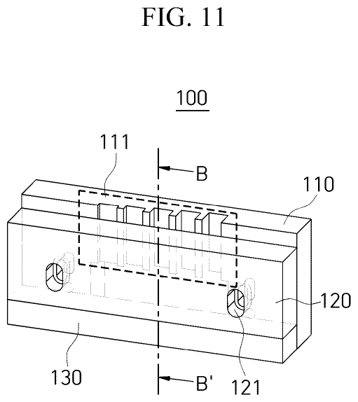

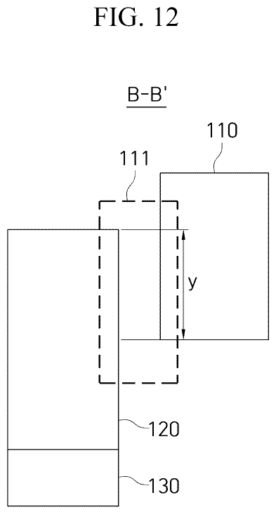

Referring to FIGS. 9 to 12, the standard jig 100 for measuring clearance according to embodiments of the present disclosure may include a linear block part (e.g., a linear block) 130 that is supported by the bottom of the second block part 120 to adjust the degree that the stepped part 111 and the second block part 120 overlap each other. In various embodiments, the linear block part 130 may have a thickness of about 0.1 mm. When the number of linear block parts 130 that are supported by the bottom of the second block part 120, as illustrated in FIGS. 11 and 12, is increased in the state in which the linear block part 130 is not present at the bottom of the second block part 120, as illustrated in FIGS. 9 and 10, an area in which the stepped part 111 and the second block part 120 overlap each other may be increased. Accordingly, a case in which the amount of insertion has been increased can be imitated.

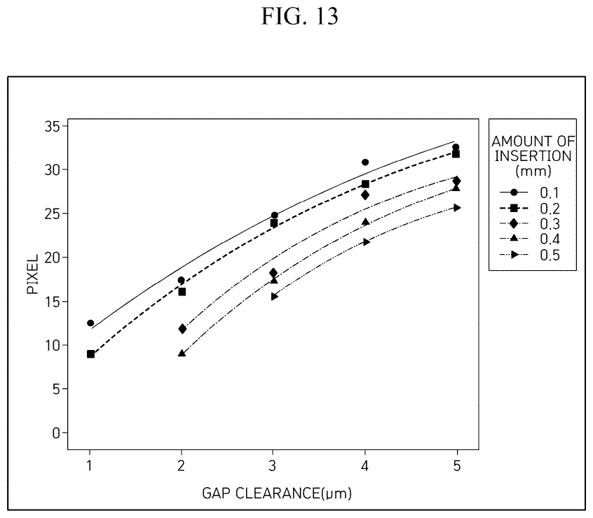

FIG. 13 is a graph illustrating results in which an image of the standard jig for measuring clearance according to embodiments of the present disclosure was analyzed by types of clearance and by amounts of insertion.

Referring to FIG. 13, the illumination part 1 of the apparatus for measuring clearance according to embodiments of the present disclosure may radiate light to or toward) the bottom of the standard jig 100 for measuring clearance in the state in which the linear block part 130, which is used to adjust the degree that the stepped part 111 and the second block part 120 overlap each other, is supported by the bottom of the second block part 120. The photographing part 2 may photograph the stepped part 111 in this state. Furthermore, the controller may analyze light that passes through each of the steps of the stepped part 111 to determine a degree that the stepped part 111 and the second block part 120 overlap, that is, for each amount of insertion. At this time, the database part may store the results of the analysis of the light for each step and the results of the analysis of each degree that the stepped part 111 and the second block part 120 overlap each other.

As illustrated in FIG. 13, the number of pixels of the image of the stepped part 111 is increased as the width of the step increases and the amount of insertion is reduced. However, the number of pixels does not increase uniformly as the width of the step or the amount of insertion increases. Accordingly, the apparatus for measuring clearance according to embodiments of the present disclosure determines the results of the analysis of light by re-measuring and analyzing the light multiple times through the standard jig for measuring clearance. The results of the analysis of the light that have been stored (e.g., stored in the database) as described above may be compared and used when the clearance C between the die 11 and the punch 12 is actually measured.

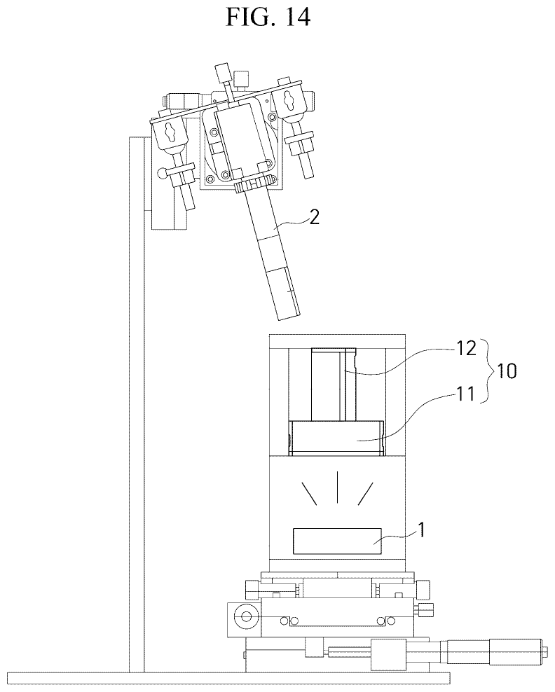

FIG. 14 is a diagram illustrating a form in which the apparatus for measuring clearance according to embodiments of the present disclosure photographs the space between the die and the punch.

Referring to FIG. 14, the illumination part 1 of the apparatus for measuring clearance according to embodiments of the present disclosure may radiate light from under a mold unit 10 including the die 11 and the punch 12 that moves vertically through the die 11. The photographing part 2 may photograph the space between the die 11 and the punch 12 in the state in which the light has been radiated by the illumination part 1 passes between the die 11 and the punch 12.

Furthermore, the controller may analyze light that is visible through (e.g., that passes through) the space between the die 11 and the punch 12 based on the image of the space between the die 11 and the punch 12 obtained by the photographing part 2, may compare the results of the analysis of the measured light and the results of the analysis of light for each step, and may derive (or determine or calculate) the clearance C between the die 11 and the punch 12 based on the results of the comparison.

As described above, the size of the clearance C between the die 11 and the punch 12 may be quantitatively and precisely evaluated in units of 1 μm by using the standard jig 100 for measuring clearance according to embodiments of the present disclosure and through this, it is possible to more accurately check the causal relationship between the quality of the sheared electrode and the mold.

Furthermore, through this confirmed causal relationship, only molds with good clearance C between die 11 and punch 12 are used to improve electrode quality problems and use evaluation data for mold processing and design change, thereby reducing the defect rate of mold unit 10 and increasing durability.

Accordingly, a maintenance frequency of the mold unit 10 can be reduced and production quantity and investment cost reduction effects can be increased by using the standard jig 100 for measuring clearance according to embodiments of the present disclosure.

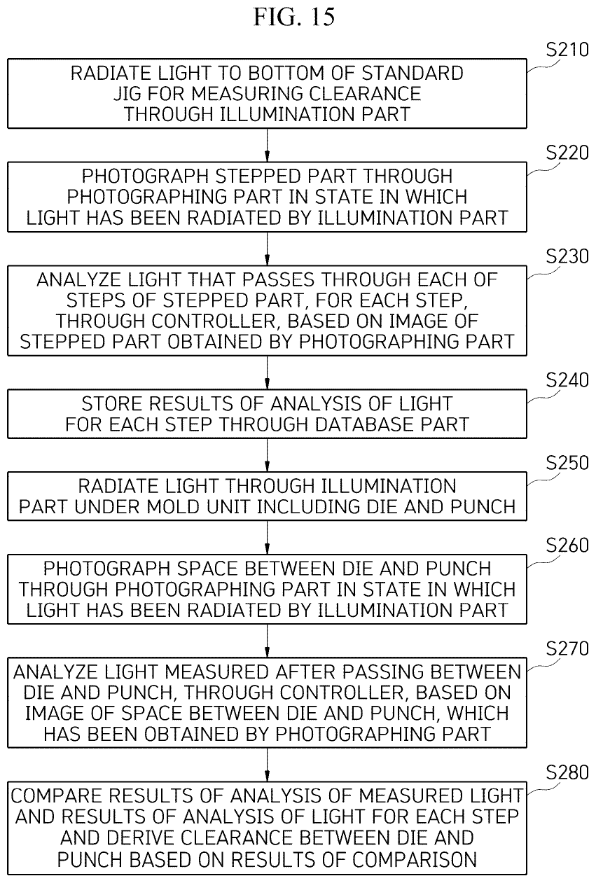

FIG. 15 is a flowchart describing steps of a method of measuring clearance according to embodiments of the present disclosure.

As illustrated in FIG. 15, the method of measuring clearance according to embodiments of the present disclosure may include steps S210 to S280.

Step S210 may be a step of radiating light to (or toward) the bottom of the standard jig for measuring clearance through the illumination part. In various embodiments, step S210 may include a step of radiating light to the bottom of the standard jig for measuring clearance through the illumination part in the state in which the linear block part for adjusting the degree that the stepped part and the second block part overlap each other is supported by the bottom of the second block part.

Step S220 may be a step of photographing the stepped part through the photographing part in the state in which the light that has been radiated by the illumination part passes through the stepped part.

Step S230 may be a step of analyzing light that passes through each of the steps of the stepped part, for each step, through the controller, based on the image of the stepped part, which has been obtained by the photographing part. In various embodiments, step S230 may include a step of analyzing light that passes through each of the steps of the stepped part in a pixel unit. Furthermore, in various embodiments, step S230 may include a step of analyzing the light that passes through each of the steps of the stepped part for each degree that the stepped part and the second block part overlap each other.

Step S240 may be a step of storing the results of the analysis of the light for each step through (or in) the database part. In various embodiments, step S240 may include a step of storing the results of the analysis of the light for each step and the results of the analysis for each degree that the stepped part and the second block part overlap through (or in) the database part.

Step S250 may be a step of radiating light through the illumination part under the mold unit including the die and the punch.

Step S260 may be a step of photographing a space between the die and the punch through the photographing part in the state in which the light has been radiated by the illumination part.

Step S270 may be a step of analyzing light that is measured after passing between the die and the punch through the controller, based on the image of the space between the die and the punch, which has been obtained by the photographing part.

Step S280 may be a step of comparing the results of the analysis of the measured light and the results of the analysis of the light for each step and deriving (or calculating) the clearance between the die and the punch based on the results of the comparison.

A method of measuring clearance according to embodiments of the present disclosure has been described with reference to the flowchart presented in the drawings. For a simple description, the method has been illustrated and described as a series of blocks, but the present disclosure is not limited to the sequence of the blocks, and some blocks may be performed in a sequence different from or concurrently (or simultaneously) with that of other blocks, which has been illustrated and described in this specification. Various other branches, flow paths, and sequences of blocks which achieve the same or similar results may be implemented. Furthermore, all the blocks illustrated to implement the method described in this specification may not be required and some may be omitted.

In the description provided with reference to FIG. 15, each of the steps may be further divided into additional steps or the steps may be combined into smaller steps depending on an implementation example of the present disclosure. Furthermore, some of the steps may be omitted, and the sequence of the steps may be changed. Furthermore, although some content is omitted, the contents of FIGS. 1 to 14 may be applied to the contents of FIG. 15. Furthermore, the contents of FIG. 15 may be applied to the contents of FIGS. 1 to 14.

Although the present disclosure has been described above with respect to embodiments thereof, the present disclosure is not limited thereto. Various modifications and variations can be made by those skilled in the art within the spirit of the present disclosure and the scope of equivalence of the appended claims.

### DESCRIPTION OF SOME REFERENCE NUMERALS

| | |
|---|---|
| 10: mold unit | 11: die |
| 12: punch | |
| 100: standard jig for measuring clearance | |
| 110: first block part | 111: stepped part |
| 112: first bolt hole | 120: second block part |
| 121: second bolt hole | |

What is claimed is:

1. A standard jig for measuring clearance, the standard jig comprising:
a first block having a stepped portion comprising a plurality of steps, each having a different clearance width; and
a second block coupled to the first block such that the second block partially overlaps the stepped portion of the first block.

2. The standard jig as claimed in claim 1, further comprising a linear block supported by a bottom of the second block to adjust a degree that the second block overlaps the stepped portion of the first block.

3. The standard jig as claimed in claim 1, wherein the first block has first bolt holes,
wherein the second block has second bolt holes, and
wherein a bolt is inserted into the first bolt hole and the second bolt hole to couple the first block and the second block.

4. The standard jig as claimed in claim 3, wherein the second bolt holes have a vertically extending slot shape to allow for adjusting a degree that the second block overlaps the stepped portion of the first block.

5. An apparatus for measuring clearance, the apparatus comprising:
a light source configured to radiate light toward a bottom of a standard jig for measuring clearance, the standard jig comprising a first block having a stepped portion comprising a plurality of steps, each having a different clearance width and a second block coupled to the first block such that the second block partially overlaps the stepped portion of the first block;
a camera configured to photograph the stepped portion of the first block in a state in which the light is radiated by the light source; and
a controller configured to analyze light that passes through each of the steps of the stepped portion, for each step, based on an image of the stepped portion obtained by the camera.

6. The apparatus as claimed in claim 5, further comprising a database configured to store results of the analysis of the light for each step.

7. The apparatus as claimed in claim 5, wherein the controller is configured to analyze the light that passes through each of the steps of the stepped portion in a pixel unit.

8. The apparatus as claimed in claim 5, wherein the light source is configured to radiate light under a mold unit comprising a die and a punch that vertically moves through the die, and
wherein the camera is configured to photograph a space between the die and the punch in the state in which the light is radiated by the light source.

9. The apparatus as claimed in claim 8, wherein the controller is configured to analyze light that is measured after passing between the die and the punch based on an image of the space between the die and the punch obtained by the camera,
wherein the controller is configured to compare results of the analysis of the measured light and results of the analysis of the light for each step, and
wherein the controller is configured to derive a clearance between the die and the punch based on results of the comparison.

10. The apparatus as claimed in claim 5, wherein the controller is configured to analyze the light that passes through each of the steps of the stepped portion for each degree that the second block overlaps the stepped portion of the first block.

11. The apparatus as claimed in claim 10, further comprising a database configured to store results of the analysis of the light for each step and results of the analysis for each degree that the second block overlaps the stepped portion of the first block.

12. The apparatus as claimed in claim 10, wherein the light source is configured to radiate the light toward the bottom of the standard jig for measuring clearance in a state in which a linear block configured to adjust the degree that the second block overlaps the stepped portion of the first block is supported by a bottom of the second block.

13. A method of measuring a clearance, the method comprising:
radiating light from a light source toward a bottom of a standard jig for measuring clearance, the standard jig comprising a first block having a stepped portion comprising a plurality of steps, each having a different clearance width, and a second block coupled to the first block such that the second block partially overlaps the stepped portion of the first block;
photographing, by a camera, the stepped portion in a state in which the light is radiated by the light source; and
analyzing light that passes through each of the steps of the stepped portion for each step, through a controller, based on an image of the stepped portion obtained by the camera.

14. The method as claimed in claim 13, further comprising storing results of the analysis of the light for each step through a database.

15. The method as claimed in claim 13, wherein the analyzing of the light comprises analyzing the light that passes through each of the steps of the stepped portion in a pixel unit.

16. The method as claimed in claim 13, further comprising:
radiating the light from the light source under a mold unit comprising a die and a punch that vertically moves through the die; and
photographing, by the camera, a space between the die and the punch in a state in which the light is radiated by the light source.

17. The method as claimed in claim 16, further comprising:
analyzing light that is measured after passing between the die and the punch, through the controller, based on an image of the space between the die and the punch obtained by the camera; and
comparing results of the analysis of the measured light and results of the analysis of the light for each step and deriving a clearance between the die and the punch based on results of the comparison.

18. The method as claimed in claim 13, wherein the analyzing of the light comprises analyzing the light that passes through each of the steps of the stepped portion for each degree that the second block overlaps the stepped portion of the first block.

19. The method as claimed in claim 18, further comprising storing results of the analysis of the light for each step and results of the analysis for each degree that the second block overlaps the stepped portion of the first block through a database.

20. The method as claimed in claim 18, wherein the radiating of the light comprises radiating the light toward a bottom of the standard jig for measuring clearance by the light source in a state in which a linear block configured to adjust the degree that the second block overlaps the stepped portion of the first block is supported by a bottom of the second block.
